(19) United States
(12) Patent Application Publication
(10) Pub. No.: US 2022/0210978 A1
(43) Pub. Date: Jul. 7, 2022

(54) SUPPORT RAIL OF AN EAR LIFTER FOR CROPS

(71) Applicant: SMF - HOLDING GMBH, Eichelhardt (DE)

(72) Inventor: Frank HÖLLER, Stein Wingert (DE)

(73) Assignee: SMF - HOLDING GMBH, Eichelhardt (DE)

(21) Appl. No.: 17/607,457

(22) PCT Filed: Apr. 25, 2020
(86) PCT No.: PCT/EP2020/061568

§ 371 Date: Oct. 29, 2021

(30) Foreign Application Priority Data
Apr. 30, 2019 (DE) 20 2019 102 446.1

(51) Int. Cl. A01D 65/02

(52) U.S. Cl. CPC A01D 65/02

(57) ABSTRACT

A support rail of an ear lifter for crops, having a major direction of extension, wherein a portion formed as a skid is disposed between a first end and a second end of the support rail, the portion formed as a skid being adapted to be guided with an outer side over a ground; and an ear lifter for a mower of a harvesting machine, comprising a stalk lifter and a support rail supporting the stalk lifter.

### CROSS REFERENCE TO RELATED APPLICATIONS

This application is a National Stage of International Application No. PCT/EP2020/061568, filed Apr. 25, 2020, claiming priority to Germany Patent Application No. 20 2019 102 446.1, filed Apr. 30, 2019.

### TECHNICAL FIELD

The following disclosure relates to a support rail of an ear lifter for crops, with a major direction of extension, wherein a section formed as a skid is arranged between a first end and a second end of the support rail, wherein the section formed as a skid is configured to be guided with its outer side over a ground, and to an ear lifter for a mowing unit of a harvesting machine, with a stalk lifter and a support rail carrying the stalk lifter.

### BACKGROUND

In known harvester mowing units, guard fingers are distributed along a cutter bar, which guide the cutter bar and form the counter-blades for the knife blades. In order to be able to mow kinked or laid stalks safely, ear lifters are used to lift the stalks. The ear lifters typically have a support rail and a stalk lifter. The support rail used to attach the ear lifter to the mower bar of the mower guides the stalk lifter, on the upper side of which the stalk material is lifted. When operating the harvester, the support rail must be guided a short distance above the ground surface so that the kinked or laid stalks can be lifted as completely and reliably as possible with the stalk lifter. The section of the support rail closest to the ground slides over the ground surface almost permanently, like a skid. Due to the increasing working speeds of the harvesters and the unevenness of the ground surface, the support rail is subject to considerable abrasive wear.

DE 101 23 248 C1 describes an ear lifter in which the support rail is made rigid in an area between the second end and a retainer by means of a profiled section. The section directly at the second end is itself sufficiently reinforced by the fastening of the stalk lifter to the support rail, so that the profiling extends to the adjoining section. These are, in particular, the slidingshoe-like section, with which the support rail rests on the ground, and the adjacent section reaching towards the retainer. For this purpose, the support rail is curved in cross-section in this section.

From the publication WO 2011/143681 A1, an ear lifter is known in which a surface is arranged in the front part of the downward-facing side of the ear lifter, which is configured to frequently slide on the ground during operation, wherein this surface is provided with a wear plating made of a material different from the material of the support rail, wherein the wear plating is formed by a plating part mounted replaceably on the ear lifter.

It is an objective to improve a support rail for an ear lifter with respect to at least one of the properties of wear, bending stiffness and torsional rigidity by means of an enhanced profiling compared to the prior art.

### SUMMARY OF THE INVENTION

The objective is met by a support rail for an ear lifter and by an ear lifter according to the independent claims. In the dependent claims, embodiments and advantageous further developments are indicated.

The support rail of an ear lifter for crops has a main direction of extension, wherein a section formed as a skid is arranged between a first end and a second end of the support rail. The section formed as a skid is configured to be guided with an outer side over a ground. The major direction of extension is also referred to as the longitudinal axis, wherein this is not to be understood as a straight line, but is to be defined along the support rail, which is generally curved in the longitudinal direction. The section formed as a skid will also be referred to simply as skid in the following. The skid is formed, for example, by a section of the support rail itself, but can also be arranged as a separate component on the support rail.

It is provided that the section formed as a skid comprises a bar, wherein the bar extends in the major direction of extension on an inner side opposite the outer side.

An advantage of the support rail is that the bar provides a profile that is more resistant to bending than a single-curved profile and also has improved wear behavior. Furthermore, the support rail with the bar has a higher torsional stiffness than a single-curved profile. The advantageously improved wear behavior results from the fact that the support rail offers greater stability under increasing wear in the section of the skid and thus a longer service life until failure occurs. In support rails with a single curvature according to the state of the art, as the skid wears a hole forms in its centre. The hole becomes larger with wear and weakens the skid to such an extent that it must be replaced. In the event of failure, part of the skid or the ear lifter may get lost. Sharp-edged fragments stuck in the ground can then destroy a tire of the harvesting vehicle, for example. Another danger if the front part of the ear lifter is lost is that it can get into the cutting unit and subsequently pass through the entire threshing elements of the harvester, where it can cause considerable damage. This results in long downtimes and high repair costs. In the case of the disclosed skid, the bar remains in place to bridge and stabilize the hole even under increasing wear. This results in an advantageously longer service life of the support rail. Furthermore, increasing wear towards the flanks, i.e. the outer areas of the skid next to the bar, will soon result in deposition of soil and harvested material. This will be clearly noticeable to the user so that he can inspect the ear lifter for its wear limit without risking a loss due to excessive weakening of the worn section.

According to an embodiment, it is provided that the bar is connected on the inner side to the section formed as a skid. In this way, two elongated slots will form under the wear described above, the combined width of which is less than the width of the single hole, and the area of which is less than the area of the hole. For example, the bar is joined to the section formed as a skid by material bonding, in particular by welding. Alternatively, the bar can be riveted and/or glued to the section formed as a skid.

According to a further embodiment, the bar is inserted into a recess in the section formed as a skid. The recess is designed in particular as a continuous slot along the main extension direction, into which the bar is inserted. The bar projects, for example, on the inner side beyond the section formed as a skid. A slot has an extension along the major direction of extension, which is at least twice as large, for example at least five times as large, as in other directions of extension.

According to a further embodiment, it is provided that the bar is made of a different material than the section formed as a skid, or than the rest of the support rail. A different material in the sense of the disclosure is also to be understood as an identical starting material with different material properties, which result, for example, from a treatment of the material. This includes in particular a hardness and/or a strength of the material, which can be influenced, for example, by a heat treatment. Hardness is the mechanical resistance of a material to the mechanical penetration of an indenter. Strength is the resistance of a material to deformation and separation. Hardness and strength can be determined by material testing methods known to the skilled person. For example, the bar is made of a material that has a greater hardness and/or strength than the material from which the skid section is made.

According to a further embodiment, it is provided that the bar is formed in the shape of a rib, so that the bar together with the section formed as a skid has a T-shaped cross-section in a section transverse to the major direction of extension. For example, the section formed as a skid has lateral flanks, wherein the lateral flanks are angled towards the inner side. For example, the section formed as a skid is concavely curved on the inner side, so that the T-shape is not to be understood in the sense that the skid must be straight in cross-section.

Along the major direction of extension, an extension of the bar in a secondary direction of extension may be constant or may vary, for example decreasing from a central area toward both sides. For example, the bar has a curvature along the major direction of extension that corresponds to a curvature of the section formed as a skid. The bar is thus advantageously adapted to the contour of the section formed as a skid.

According to a further embodiment, it is provided that the bar has a base plate, wherein the base plate is connected to the section formed as a skid. The base plate advantageously facilitates the connection of the bar to the section formed as a skid, in particular if the latter is not inserted in a recess. Advantageously, the base plate provides a surface for making an adhesive connection or a riveted connection.

The disclosure is not limited to a support rail having only one bar. The skilled person will recognize that an embodiment is conceivable in which the section formed as a skid has on the inner side, in addition to the bar, at least one further bar extending in the major direction of extension, wherein the bars are arranged in particular parallel to one another.

A further aspect relates to an ear lifter for a mower unit of a harvesting machine, which meets the above-mentioned objective. The ear lifter comprises a stalk lifter and a support rail supporting the stalk lifter, as previously described.

The stalk lifter is arranged, for example, at the second end of the support rail, wherein the section formed as a skid joins the second end and wherein the bar extends to the stalk lifter. The stalk lifter may have a V-shaped profile in cross-section, wherein the bar extends into the V-shaped profile such that one end of the bar is disposed between the legs of the V-shaped profile. The bar may be connected to the stalk lifter.

### DESCRIPTION OF THE DRAWINGS

In the following, further features and advantages will be explained in more detail by means of exemplary embodiments with reference to the accompanying drawings. The explanations are merely exemplary and do not limit the general idea of the invention.

In the Figures show

FIG. 1 a perspective view of an embodiment of the ear lifter with a support rail;

FIGS. 2a and 2b two detailed perspective views of an embodiment of the support rail;

FIGS. 3a and 3b two perspective detail views of a further embodiment of the support rail;

FIGS. 4a and 4b two detailed perspective views of yet a further embodiment of the support rail.

### DETAILED DESCRIPTION

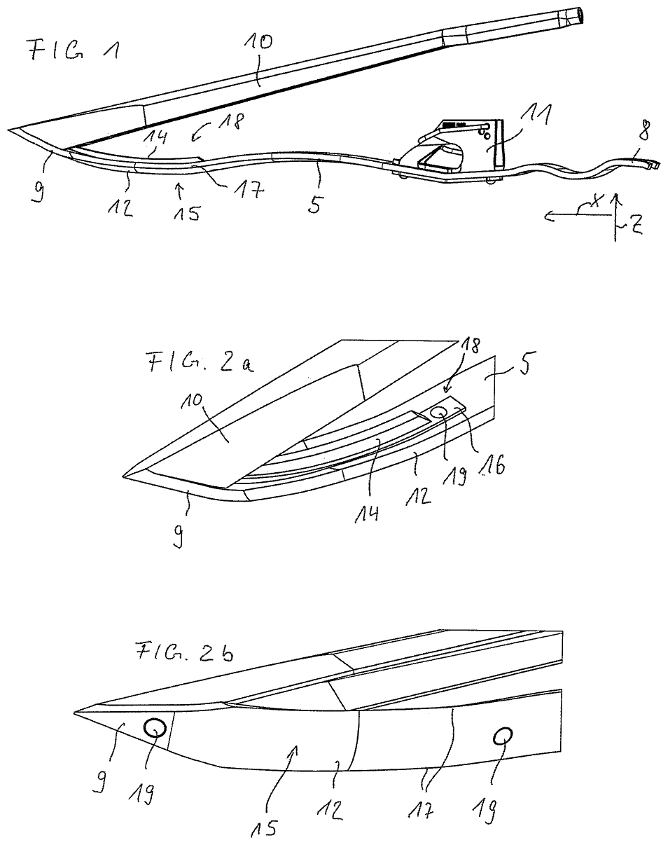

FIG. 1 shows an exemplary embodiment of an ear lifter with a support rail 5. A first end 8 of the support rail 5, which is made from a flat material as the starting material, is provided for attachment to a mower bar of a harvesting machine, which is not shown. At a second end 9 remote from the first end 8, a stalk lifter 10 is attached to the support rail 5 to form an acute angle with the support rail 5. The support rail 5 comprises a retainer 11, which is configured to rest on a finger guard, which is not shown. The support rail 5 extends along a major direction of extension X from the first end 8 to the second end 9, with an outer side 15 facing the ground during operation on a harvesting machine. The section 12 of the support rail 5, formed as a skid, is configured to slide over the ground, which is not shown, and is accordingly subject to considerable wear. Viewed from an inner side 18, the support rail 5 is concavely curved in the section of the skid 12, so that flanks 17 of the skid 12 enclose an acute angle with the ground during operation.

The section 12 formed as a skid is configured to be guided over the ground with the outer side 15. The section 12 formed as a skid comprises a bar 14, wherein the bar 14 extends in the major direction of extension X of the support rail 5 on the inner side 18 opposite the outer side 15. Since the major direction of extension X of the support rail 5 coincides with that of the bar 14, the term major direction of extension X hereinafter refers to both components. A secondary direction of extension Z of the bar 14 in the form of a rib is oriented substantially orthogonal to the major direction of extension X. The directional arrows are not to be understood as Cartesian coordinate axes, but are merely intended to illustrate the directions of extension in the slightly perspective view. In the further Figures, no direction arrows are indicated. The directions given in FIG. 1 apply mutatis mutandis to all Figures.

In the exemplary embodiment of the ear lifter according to FIG. 1, the stalk lifter 10 is arranged at the second end 9 of the support rail 5, wherein the section 12 formed as a skid is arranged adjacent to the second end 9 and wherein the bar 14 extends all the way to the stalk lifter 10. The stalk lifter 10 has a V-shaped profile in cross-section, wherein the bar 14 extends into the V-shaped profile.

FIGS. 2a and 2b show two partial views of an embodiment of the support rail 5 for an ear lifter according to FIG. 1, of which the section 12 formed as a skid is shown in detail. Both Figures are described together. An extension of the bar 14 along the major direction of extension X in a secondary direction of extension Z (cf. FIG. 1) is constant. The bar 14 has a curvature along the major direction of extension X, which is adapted to the section 12 formed as a skid. In the embodiment shown, the bar 14 has a base plate 16 which is connected to the section 12 formed as a skid. The base plate 16 serves to connect the bar 14 to the section 12 formed as a skid, which is realized here by fasteners in the form of rivets 19.

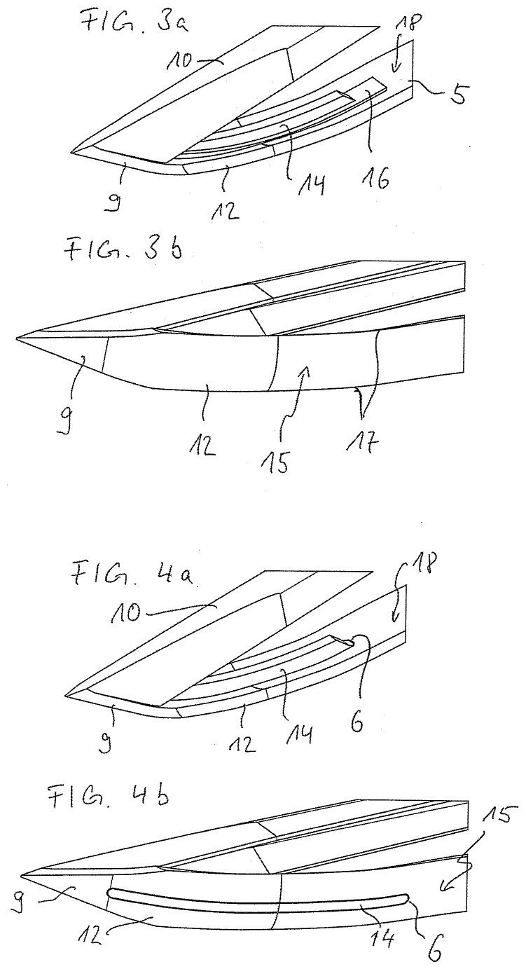

FIGS. 3a and 3b show two partial views of a further embodiment of the support rail 5 for an ear lifter according to FIG. 1, of which the section 12 formed as a skid is shown in detail. Both Figures are described together. The embodiment differs from the embodiment shown in FIGS. 2a and 2b in that the base plate 16 is connected to the section 12 formed as a skid in a different manner, namely without fasteners. The base plate 16 is connected to the section 12 formed as a skid, for example, by an adhesive connection, a soldered connection or by a welded connection.

FIGS. 4a and 4b show two partial views of a further embodiment of the support rail 5 for an ear lifter according to FIG. 1, of which the section 12 formed as a skid is shown in detail. Both Figures are described together. The embodiment differs from the embodiment shown in FIGS. 2a and 2b in that the bar 14 is connected in a different manner to the section 12 formed as a skid. The bar 14 does not have a base plate, but is inserted into a slot-like recess 6 of the section 12 formed as a skid. The recess 6 runs along the major direction of extension X (cf. FIG. 1) and is provided through from the inner side 18 to the outer side 15. The bar 14 is flush with the outer side 15, for example. On the inner side 18 the bar 14 protrudes therefrom, for example.

The bar 14 is joined to the section 12 formed as a skid, for example by a welded connection (not shown). Alternatively, in the embodiment according to FIGS. 4a and 4b, there is also the option of attaching the bar 14 to the section 12 formed as a skid by means of a riveted connection. For example, the rivets (not shown) are prefabricated as protruding portions on the bar 14. After the bar 14 is inserted into the recess 6, the protruding rivets are machined from the outer side 15 so that the bar 14 is firmly connected. In particular, the rivets are provided at the ends of the bar 14, which are driven into the ends of the recess 6 under deformation to form the connection. Another alternative is not to make the recess slot-like, but instead to provide a plurality of bores, wherein the rivets prefabricated as projecting portions on the bar 14 are inserted into the bores and riveted therein. In that case, with the exception of the rivets, the bar 14 is arranged on the inner side 15.

A further alternative of the embodiment according to FIGS. 4a and 4b is that the bar 14 protrudes on the outer side 15, in particular in the same way as on the inner side 18, so as to advantageously further reduce wear on the outer side 15.

### REFERENCE NUMERALS

5 Support rail
6 Slot-like recess
8 First end of support rail
9 Second end of support rail
10 Stalk lifter
11 Retainer
12 Section designed as skid
14 Bar
15 Outer side
16 Base plate
17 Flank
18 Inner side
19 Rivet
X Major direction of extension, longitudinal axis
Z Secondary direction of extension

1. A support rail of an ear lifter for crops, with a major direction of extension, wherein a section formed as a skid is arranged between a first end and a second end of the support rail, wherein the section formed as a skid is configured to be guided with its outer side over a ground, wherein the section formed as a skid comprises a bar, wherein the bar extends in the major direction of extension on an inner side opposite the outer side.

2. The support rail according to claim 1, wherein the bar is connected on the inner side to the section formed as a skid.

3. The support rail according to claim 1, wherein the bar is made of a different material than the section formed as a skid.

4. The support rail according to claim 1, wherein the bar is inserted into a recess of the section formed as a skid.

5. The support rail according to claim 4, wherein the bar projects on the inner side beyond the section formed as a skid.

6. The support rail according to claim 1, wherein the bar is formed in the shape of a rib, wherein the bar with the section formed as a skid has a T-shaped cross-section in a section transverse to the major direction of extension.

7. The support rail according to claim 1, wherein the bar has a curvature along the major direction of extension which corresponds to a curvature of the section formed as a skid.

8. The support rail according to claim 1, wherein the bar has a base plate, wherein the base plate is connected to the section formed as a skid.

9. The support rail according to claim 1, wherein the section formed as a skid has lateral flanks, wherein the lateral flanks are angled towards the inner side.

10. The support rail according to claim 1, wherein the section formed as a skid has on the inner side, in addition to the bar, at least one further bar extending in the major direction of extension.

11. An ear lifter for a mowing unit of a harvesting machine, comprising the support rail according to claim 1 supporting a stalk lifter.

12. The ear lifter according to claim 11, wherein the stalk lifter is arranged at the second end of the support rail, wherein the section formed as a skid is adjacent to the second end and wherein the bar extends to the stalk lifter.

13. The ear lifter according to claim 12, wherein the stalk lifter has a V-shaped profile in cross-section, wherein the bar extends into the V-shaped profile.

14. A support rail of an ear lifter for crops, with a major direction of extension, wherein a section formed as a skid is arranged between a first end and a second end of the support rail, wherein the section formed as a skid is configured to be guided with its outer side over a ground, wherein the section formed as a skid comprises a bar, wherein the bar extends in the major direction of extension on an inner side opposite the outer side, wherein the bar is inserted into a recess of the section formed as a skid.

15. The support rail according to claim 14, wherein the bar is made of a different material than the section formed as a skid.

16. The support rail according to claim 14, wherein the section formed as a skid has on the inner side, in addition to the bar, at least one further bar extending in the major direction of extension.

17. A support rail of an ear lifter for crops, with a major direction of extension, wherein a section formed as a skid is arranged between a first end and a second end of the support rail, wherein the section formed as a skid is configured to be guided with its outer side over a ground, wherein the section formed as a skid comprises a bar, wherein the bar extends in the major direction of extension on an inner side opposite the outer side, wherein the bar has a base plate, wherein the base plate is connected to the section formed as a skid.

18. The support rail according to claim 15, wherein the bar is made of a different material than the section formed as a skid.

19. The support rail according to claim 15, wherein the section formed as a skid has on the inner side, in addition to the bar, at least one further bar extending in the major direction of extension.

20. An ear lifter for a mowing unit of a harvesting machine, comprising the support rail according to claim 15 supporting a stalk lifter.
